(19) United States
(12) Patent Application Publication
(10) Pub. No.: US 2016/0125493 A1
(43) Pub. Date: May 5, 2016

(54) CLIENT-BASED PRODUCT CONFIGURATOR ON OPTIMIZED DATA STRUCTURES

(71) Applicant: Reshat Furunzhyieu, Wiesloch (DE)

(72) Inventor: Reshat Furunzhyieu, Wiesloch (DE)

(21) Appl. No.: 14/526,876

(22) Filed: Oct. 29, 2014

(51) Int. Cl. G06Q 30/06

(52) U.S. Cl. CPC G06Q 30/0621; G06Q 30/0641

(57) ABSTRACT

Methods, systems, and computer-readable storage media for configuring products based on a client-side product configurator. Implementations include actions of transmitting a variant product configurator (VPC) to a client-side computing device, the VPC comprising instructions the are executable to configure a product, receiving a first request, and in response, transmitting default product configuration data to the client-side computing device, receiving a second request, and in response, transmitting complete product configuration data to the client-side computing device, the complete product configuration data being stored in an in-memory database, receiving product configuration data including one or more user-selected features for the product and corresponding pricing information, and storing the product configuration data in computer-readable/-writable memory.

### BACKGROUND

Enterprise software is rapidly changing in view of increased business demands, the introduction of modern technologies, market trends, and end-user expectations. One relatively competitive area is variant product configuration. In some examples, variant product configuration supports the order and manufacture of complex products. That is, for example, a manufacturer can offer variants of its products (e.g., computers), where a variant product configurator (VPC) is provided to enable a user (e.g., customer) to configure (or modify) existing product designs as the order is processed. In other words, the customer determines the features of the product (e.g., a customer buying a computer can choose the features of the computer, such as processor, random access memory (RAM), storage space, screen size, etc.). In some examples, the VPC improves information exchange between sales, engineering, and production. Variant configuration helps the customer (or sales person), for example, define specifications for the product and ensure that the product can be produced from the specifications.

In some examples, the VPC is server-based. That is, for example, the VPC functionality is hosted on and executed by one or more servers. Although the server-based VPC provides flexibility for the product configuration logic and a data model, the configuration, processing and validation logic can be very hardware resource intensive (e.g., requiring significant processing power and/or memory). This can be particularly true for high volume and throughput environments, which results in increased runtime, high hardware consumption and high total cost of ownership (TCO). For example, during periods such as “Black Friday” and “Cyber Monday,” VPC use can spike, requiring significantly more server-side hardware resources for product configuration than typically required throughout the year.

### SUMMARY

Implementations of the present disclosure include computer-implemented methods for configuring products based on a client-side product configurator. In some implementations, actions include transmitting a variant product configurator (VPC) to a client-side computing device, the VPC comprising instructions the are executable to configure a product, receiving a first request, and in response, transmitting default product configuration data to the client-side computing device, receiving a second request, and in response, transmitting complete product configuration data to the client-side computing device, the complete product configuration data being stored in an in-memory database, receiving product configuration data including one or more user-selected features for the product and corresponding pricing information, and storing the product configuration data in computer-readable/-writable memory. Other implementations of this aspect include corresponding systems, apparatus, and computer programs, configured to perform the actions of the methods, encoded on computer storage devices.

These and other implementations can each optionally include one or more of the following features: one or more of the default configuration data and the complete configuration data are provided based on one or more sub-models; the one or more sub-models are provided based on at least one variant configuration model; actions further include verifying an integrity of the product configuration data based on a hash-sum value; the VPC is stored in a cache of a browser application and is executed by the browser application; the first request and the second request are transmitted based on the instructions of the VPC; and the VPC is transmitted in response to one of a user navigating to a page of a website, and the user logging into the website.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example high-level architecture in accordance with implementations of the present disclosure.

FIG. 2 depicts an example product configuration system in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to a product configuration system that includes a client-based variant product configurator (VPC). More specifically, and in some implementations, the product configuration system includes the client-based VPC, a server-based configuration server, and a server-based model designer. In some implementations, the client-based VPC is provided as computer-executable instructions stored in a client browser cache (e.g., Internet browser, mobile browser). In some examples, the client-based VPC is provided as a Java script. In some implementations, the configuration server provides functionality for uploading variant configuration models (VCMs) to an in-memory database. In some implementations, the model designer provides functionality to convert the uploaded VCMs to one or more simplified models (e.g., sub-models, geo-models, season-models, special-models, etc.). In some examples, a simplified model is based on an optimized data structure and one or more rules, and are stored in the database.

In some implementations, the client-based VPC loads a desired product model (e.g., simplified model) and any pricing surcharges from the configuration server, and is used (by the user) to configure a product. When the configuration is complete, the client-side VPC a configuration file (e.g., a computer-readable file describing one or more configured products) is sent to the configuration server for validation and processing. In some examples, the one or more configured products are stored by a server-side application as standard products with respective pre-calculated prices. In some examples, the configuration server separately stores the configuration files with a unique key.

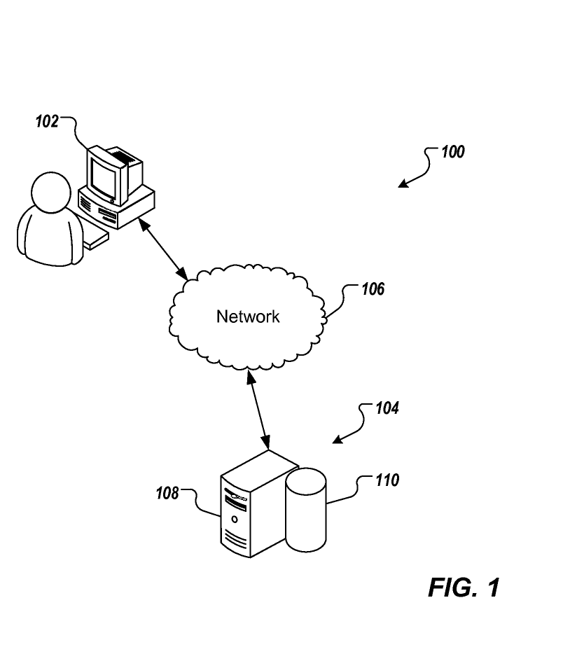

FIG. 1 depicts an example high-level architecture 100 in accordance with implementations of the present disclosure. The high-level architecture 100 includes a computing device 102, e.g., client-side, a server system 104 and a network 106. In some examples, the computing device 102 and the server system 104 communicate over the network 106. In accordance with implementations of the present disclosure, the server system 104 can enable a user (e.g., a user of the computing device 102) to configure, order and purchase one or more products). As described in further detail herein, a client-side VPC can be provided to the computing device 102, and can be executed by the computing device 102 to enable the user to configure a product.

Implementations of the present disclosure will be described herein with reference to an example context. The example context includes user-configuration of a computer (e.g., a product) sold by a seller. In some examples, a standard computer (default computer) is provided (e.g., with base features such as a base processor type, a base random access memory (RAM) size, a base storage space, and the like. For example, an example standard computer for a particular seller can include a single core processor, 2 GB of RAM, and a 200 GB hard-disk drive (HDD). In some examples, the standard computer can include a base price (default price) (e.g., $350).

Continuing with this example, the standard computer can be configured by a user to provide a user-configured computer. In some examples, the seller can provide two or more options for each feature, which the user can select. In some examples, an option may be associated with a price surcharge. For example, the seller can enable the user to keep the base storage space (e.g., the 200 GB HDD), or select one or more enhanced storage spaces with respective price surcharges. For example, instead of the base storage space the user can select a 200 GB solid-state drive (SSD) for a price surcharge of $100, or a 500 GB hybrid drive (e.g., SSD and HDD) for a price surcharge of $150. As another example, the seller can enable the user to keep the base processor (e.g., the single core processor), or select one or more enhanced processors with respective price surcharges. For example, instead of the base processor the user can select a dual-core processor for a price surcharge of $100. As another example, the seller can enable the user to keep the base RAM (e.g., the 2 GB of RAM), or select one or more enhanced RAM sizes with respective price surcharges. For example, instead of the base RAM size the user can select 4 GB of RAM for a price surcharge of $100, 8 GB of RAM for a price surcharge of $250.

Although implementations of the present disclosure are described in further detail herein with reference to the above-described example context, it is appreciated that implementations of the present disclosure can be used in any appropriate context. For example, implementations of the present disclosure can be used to enable configuration, purchase and order of clothing (e.g., shoes), cars, or any other appropriate configurable product and/or service.

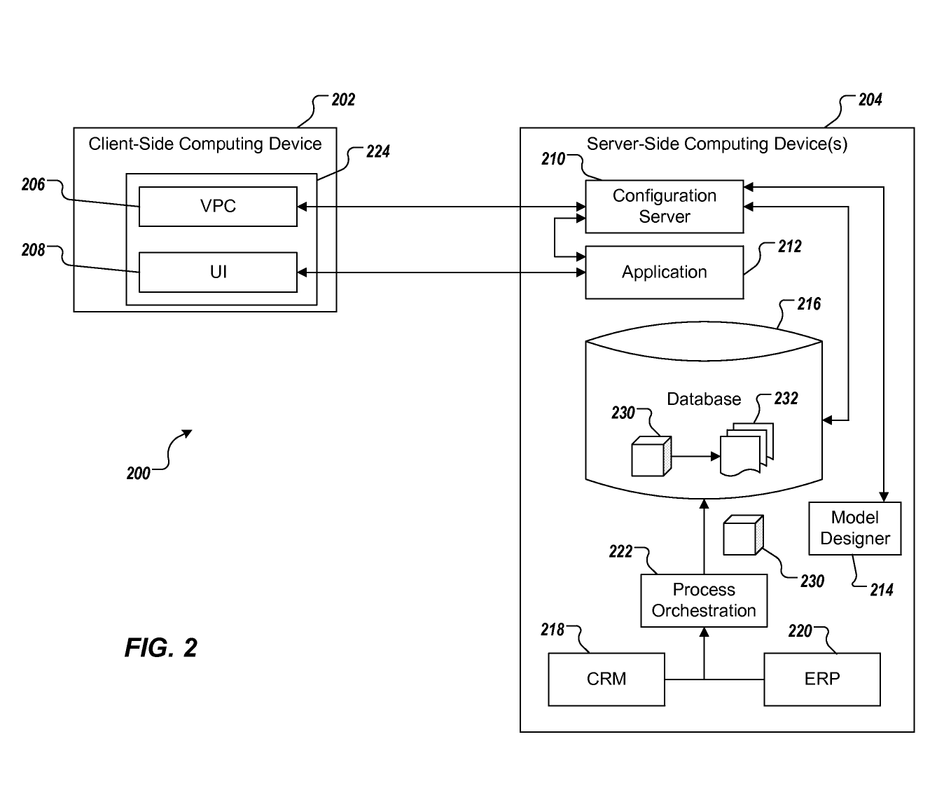

As introduced above, implementations of the present disclosure provide a product configuration system that include a client-based VPC, a server-based configuration server, and a server-based model designer. FIG. 2 depicts an example product configuration system 200 in accordance with implementations of the present disclosure. The example product configuration system 200 includes a client side computing device 202 (e.g., the computing device 102 of FIG. 1) and one or more server-side computing devices 204 (e.g., the server system 104 of FIG. 1). In the example of FIG. 2, the computing device 202 provides a client-based VPC 206 and a user interface (UI) 208. In the example of FIG. 2, the one or more computing devices 204 provide a configuration server 210, an application 212, a model designer 214, a database 216, a customer relationship management (CRM) platform 218, an enterprise resource planning (ERP) platform 220, and a process orchestration platform 222.

In some implementations, the computing device 202 executes a browser application 224 (e.g., Internet browser, mobile browser). For example, the browser application 224 can be provided as one or more computer-executable programs that can be executed by the computing device 202. In some implementations, the VPC 206 is received from the one or more computing devices 204. In some examples, the VPC 224 is provided as computer-executable instructions that are stored in a cache of the browser application 224. For example, the VPC 206 can be provided as Javascript. In some implementations, the browser application 224 enables a user of the computing device 202 (e.g., the user of FIG. 1) to interact with the application 212 to configure, order and purchase one or more products, as described herein. For example, the application 212 can be a web application that is provided by, or on behalf of, a retailer of products and/or services, and that enables users to configure, order and purchase one or more products. To that end, a session can be established between the application 212 and the browser application 224. For example, using the browser application 224, the user can navigate to a home page of a website of the retailer, to interact with the application 212. In some examples, the browser application 224 displays the UI 208, which includes one or more components that the user can interact with to configure, order and purchase one or more products.

In some implementations, the configuration server 210, the application 212 and the model designer 214 are each provided as one or more computer-executable programs that are executed by the one or more computing devices 204. In some examples, the database 216 is provided as an in-memory database, described above. In some examples, the CRM platform 218, the ERP platform 220 and the process orchestration platform 222 are each provided as one or more computer-executable programs that are executed by the one or more computing devices 204. An example CRM platform, an example ERP platform and an example process orchestration platform, respectively include SAP CRM, SAP ERP Central Component (ECC), and SAP NetWeaver Process Orchestration, provided by SAP SE of Walldorf, Germany.

In some implementations, the process orchestration platform 222 stores one or more VCMs 230 to the database 216. In some examples, a VCM 230 is provided as a computer-readable/-writable file that includes one or more objects and relationships between objects. In some instances, a VCM can have a significantly complex structure. For example, a configurable product can have a relatively large number of configurable characteristics, and/or a relatively large number of values that can be assigned to the configurable characteristics. As another example, a VCM can include one or more dependency rules between characteristics (e.g., if a first characteristics has a particular value, a second characteristic cannot be selected). In terms of storage, a relatively complex VCM can require upwards of 100 MB or more for storage.

In some examples, the process orchestration platform receives the one or more VCMs 230 from the CRM platform 218 and/or the ERP platform 220. For example, the CRM platform 218 and/or the ERP platform 220 can be used (e.g., by a user) to define one or more VCMs 230. In some examples, the CRM platform 218 and/or the ERM platform 220 can store one or more VCMs 230 directly to the database 216 (e.g., without going through the process orchestration platform 222).

In some implementations, the model designer 214 provides functionality to convert a VCM into one or more simplified models 232. In some examples, a simplified model is based on an optimized data structure and rules. Example simplified models can include a sub-model, a geo-model, a seasonal-models, and a special-models. For example, a simplified model can include a reduced number of configurable characteristics, available values of characteristics, and/or dependency rules relative to the VCM, from which the model is provided. In some examples, a simplified model can be focused on a particular aspect (e.g., customer, location, campaign, season). For example, a particular VCM can be provided for all types of customers (e.g., corporate, private) in any location (e.g., global). A simplified model of the particular VCM can be provided for only private customers that are located in the United States. In this manner, and in terms of memory, a simplified model can require only 100 kB for storage, while the underlying VCM requires upwards of 100 MB or more for storage, for example.

In some examples, the model designer provides an administrator console (e.g., a graphical user interface (GUI) displayed to an administrator user) for maintenance and management of the simplified models 232. In some examples, the model designer 214 interacts with the configuration server 210 to provide the described functionality. In some examples, the model designer 214 is a Java application provided to manage and design the models on the configuration server 214, as described herein.

In some implementations, the configuration server 210 provides functionality for uploading the VCMs 230 to the database 216 (e.g., from the process orchestration platform 222, from the CRM platform 218, and/or from the ERP platform 220). In some examples, the configuration server 204 interacts with the model designer 214 and stores the simplified models 232 in the database 216. In some examples, the configuration server 210, enables reading of the simplified models 232 from the database 216 during the client-configuration with a single request, as described in further detail herein. In some examples, the configuration server 210 is provided as a server application (e.g., Java server application) and includes a database layer.

In some implementations, a relatively significant performance advantage can be provided by in-memory database systems. For example, an in-memory database having a column-based data architecture provides an efficient real-time VCM data read upon request. In some examples, the model designer 214 can be used to create unique records for each VCM. In some examples, predefined data views boost access to the underlying data.

In some implementations, the application 212 is provided as one or more computer-executable programs executed by the one or more computing devices 204. In some examples, the application 212 is a web application that enables a user to configure, order and purchase one or more products. In some examples, a session (e.g., hypertext transfer protocol (HTTP) session) is established between the browser application 224 and the application 212. For example, a secure session can be established using a cryptographic protocol (e.g., secure sockets layer (SSL), transport layer security (TLS)). In some examples, and as described in further detail herein, the configuration server 210 provides the VPC 206 for storage in the browser cache. For example, the VPC 206 can be transmitted from the configuration server 210 to the browser application 224 in response to the session being established. In some examples, the application 212 provides the UI 208, through which the user interacts with the application 212 to configure, order and purchase one or more products.

In some implementations, user interaction with the UI 208 can trigger downloading of a simplified model. For example, the user can interact with the UI 208 to select a product (e.g., a computer) that is to be configured by the user. In response to selection of the product, for example, the VPC 206 (automatically) sends a request for a respective simplified model (product model), which models the selected product. In some examples, the product model is retrieved from the database 216 and is transmitted to the VPC 206 (e.g., by the configuration server 210). In some examples, pricing surcharges associated with features of the product are transmitted to the VPC 206 along with the product model. In this manner, the product model and pricing surcharges are transmitted to the VPC 206 in response to a single request issued by the VPC 206. In some examples, the product model and pricing surcharges are cached by the browser application for configuring the underlying product. In some implementations, and as described in further detail herein, once the product configuration is complete (e.g., the user selects an “order” button displayed in the UI 208), configuration data is sent to the configuration server 210 for validation and processing (e.g., from the VPC 206). In some examples, the configured product (configuration model populated with configuration data) is stored by the application as a standard product with the pre-calculated price data that is based on the configured product. In some examples, the product is stored with a unique identifier (e.g., a unique key). In some implementations, the configuration server 210 stores the configuration data, which indicates the features selected by the user for the particular product, with the unique key. In this manner, the unique key can be used to associated the standard product and pricing data stored by the application 212 with the configuration data stored by the configuration server 210.

In some implementations, the system 200 provides functionality to inhibit any unauthorized data manipulation on the client-side (e.g., the user changing the price to reflect a lower price by manipulating the product configuration (hidden characteristics, dependencies) or price (campaigns, characteristic surcharges, etc.)). In some examples, the VPC 206 generates a first hash-sum when the finalized configuration is transmitted to the configuration server 210. In some examples, before the order is finally committed for manufacture of the configured product, the configuration server controls both the configuration data and the hash sum. Once the order is to be committed (e.g., payment is to be made) The hash sum check improves the commercial security and excludes the risk of any manipulations.

In accordance with implementations of the present disclosure, and as described herein, product configuration functionality is provided and includes: provisioning of configuration data; configuration data modeling, verification and storage; and client-based configuration. In some examples, provisioning of configuration data starts from an interface that provides VCMs (e.g., knowledge bases) and relevant pricing information from one or more backend systems (e.g., the CRM platform 218 and/or the ERP platform 220 of FIG. 2) to the configuration server. In some examples, each VCM is provided in its original format (e.g., XML) through a standard interface (e.g., secure file transfer protocol (SFTP)). The configuration server receives the VCM and writes (create/update) the VCM into the database (e.g., 1:1 without any data processing). In some examples, the configuration server can operate as a proxy to resend the original configuration files and/or the sub-models to other ‘slave’ configuration servers (e.g., clustered approach).

In some implementations, the model designer provides the configuration data modeling functionality, which enables the sub-models (simplified models) to be created from the original VCM using an authoring user interface. In some examples, the sub-models are saved and stored on the database. In some implementations, the data for each sub-model is stored in parallel in two structures: a default product configuration and default start price; and a complete product configuration model and corresponding pricing conditions. In this manner, quick access to the data is available based on different purposes. In some examples, a verification function enables receipt and verification of the configuration models received from the client, as well as simulating the configuration function for the quality assurance purposes.

In some implementations, and as described herein, the configurable product is stored on the server side as multiple data objects, which include: a document item (simple product) with the configuration key on the application side, and a product configuration under its configuration ID on the configuration server side.

In some implementations, and as described herein, the client-based VPC is provide as a compact (in terms of resources required to execute) client engine, compiled as a single module (file). In some implementations, the VPC is generic, and can be executed regardless of the particular browser application. Further, the VPC is flexible for all product configuration models. The VPC is loadable by an Internet browser or a mobile browser synchronously or asynchronously during the online web session, and is cacheable by the client-side browser cache. In some examples, a pricing processor is provided as part of the VPC, and updates (recalculates) product price during the product configuration process. For example, product pricing is updated by the pricing processors based on the combination of the selected configuration options. The communication between the VPC and the configuration server is secure and is performed using secure protocol (e.g., SSL, TLS).

An example business process will be described based on implementations of the present disclosure. In some examples, the business process includes configuring a product for purchase. In general, a product configuration business process is designed based on the consumer-oriented experience and personalized functionality. End-user performance and smooth navigation flow are factors for a successful web application from an end-user point-of-view. In some examples, for each application that will provide a client-side VPC, the application loads the configuration engine of the VPC (E.g., Javascripts) asynchronously and seamlessly. In some examples, the VPC is received and loaded in response to a home page load or successful execution of an authentication process (e.g., user login). This enables the speed of the configuration start-up to be increased.

In some implementations, in response to the user indicating that a product is to be configured, the VPC is executed from the browser cache and perform multiple calls including: a synchronous call to the configuration server to load the default configuration model and default prices (small start data set) for the particular product; and an asynchronous call to the configuration server to load the full product configuration and all pricing conditions (complete data set). As described above, during the configuration process, the VPC updates the product price based on the feature selection (e.g., the user-defined configuration). In some examples, after the configuration is complete and the “Add to cart” button is selected, for example, the configuration data is sent to the application and to the configuration server. In some examples, the configuration server perform the consistency check (the hash-sum check described above) and saves the configuration in a temporary store.

In some implementations, during the checkout process, the application triggers the configuration server to save the configuration data to the database, and generate the configuration key. The document items containing the configuration data and stored in the database reference the configuration key, and an order is forwarded to one or more backend systems for execution of an order fulfillment process.

In some implementations, the VPC and configuration data can be cleared from the browser cache, in response to completion of the order (e.g, the checkout process is completed). In some examples, and in the event of a change to the order, the document item will be updated using the configuration key. After changes are made, the configuration server saves the updated product configuration using the same configuration key.

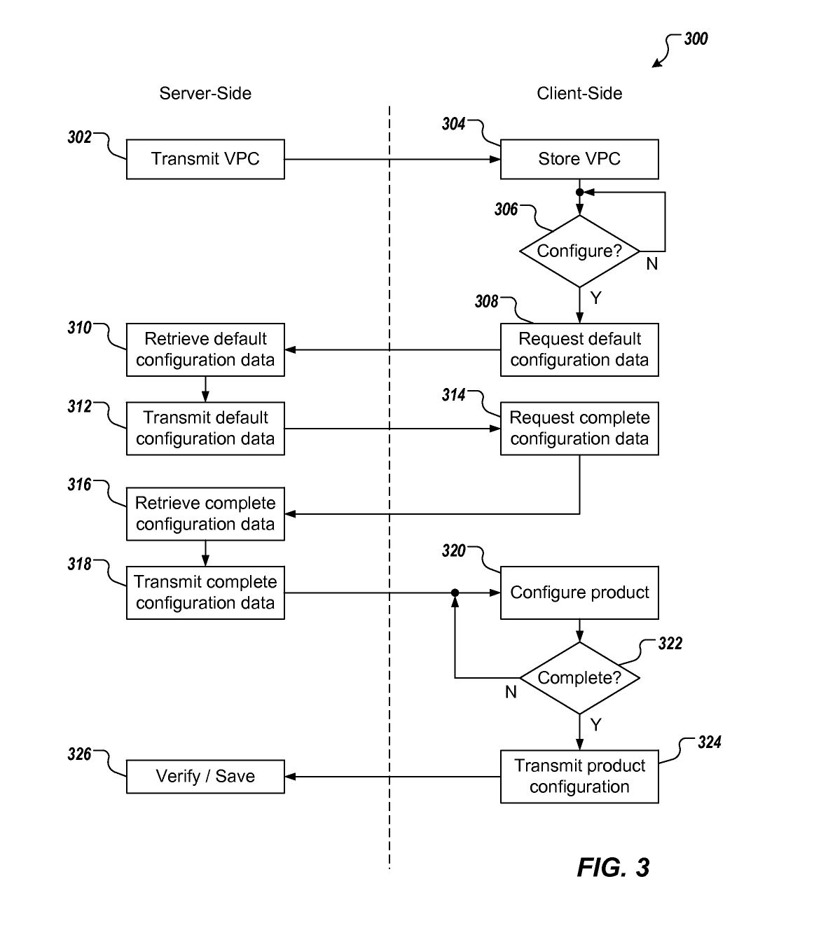

FIG. 3 depicts an example process 300 that can be executed in accordance with implementations of the present disclosure. In some examples, the example process 300 can be provided as one or more computer-executable programs executed using one or more computing devices. In some examples, the configuration server 210, the application 212, and the browser application 224 (e.g., executing the VPC 206), each perform one or more operations of the example process 300.

A VPC is transmitted (302). For example, the server-side (e.g., the server-side computing devices 204 of FIG. 2), transmit the VPC 206 to the client-side computing device 202. In some examples, the VPC 206 is transmitted in response to the user visiting a home page of a website, through which the user can interact with the application 212. In some examples, the VPC 206 is transmitted in response to the user logging in to the application 212. The VPC is stored (304). For example, the VPC 206 is stored in the cache of the browser application 224.

It is determined whether a product is to be configured (306). For example, user input can be received by the application 212 (e.g., from the browser application 224), which indicates that the user has selected a product (e.g., computer) that is to be configured. If it is determined that a product is not to be configured, the process 300 loops back. If it is determined that a product is to be configured, the VPC 206 executes (e.g., the browser application 224 starts the VPC 206) and default configuration data for the product is requested (308). In some examples, the browser application 224, which is executing the VPC 206, sends a synchronous call to the configuration server 210 to request the default configuration data. The default configuration data is retrieved (310). For example, the configuration server 210 retrieves the default configuration data from the database 216. In some examples, the default configuration data provides the default product configuration and corresponding pricing (e.g., the default computer that includes a single core processor, 2 GB of RAM, and a 200 GB hard-disk drive (HDD), for a default price of $350. The default configuration data is transmitted (312). For example, the configuration server 210 transmits the default configuration data to the browser application 224.

Complete configuration data is requested (314). In some examples, the browser application 224, which is executing the VPC 206, sends an asynchronous call to the configuration server 210 to request the complete configuration data. The complete configuration data is retrieved (316). For example, the configuration server 210 retrieves the complete configuration data from the database 216. In some examples, the complete configuration data provides the product options and corresponding pricing (e.g., a 200 GB SSD for a price surcharge of $100, a 500 GB SSD/HDD for a price surcharge of $150; a dual-core processor for a price surcharge of $100; 4 GB of RAM for a price surcharge of $100, 8 GB of RAM for a price surcharge of $250). The complete configuration data is transmitted (318). For example, the configuration server 210 transmits the default configuration data to the browser application 224.

The product is configured (320). For example, the user can interact with the browser application 224, which executes the VPC 206, to configure the product. For example, the user can select a dual-core processor instead of the default single-core processor. In some examples, and as described herein, a pricing processor of the VPC 206 updates (recalculates) product price during the product configuration process. For example, in response to the user selecting the dual-core processor, the default price of $350 can be recalculated to provide a price of $450.

It is determined whether the product configuration is complete (322). In some examples, it can be determined that the configuration is complete in response to user input. For example, the user can select an “Add to Cart” option (e.g., a button displayed in the UI 208), and in response, it can be determined that the configuration is complete. If it is determined that the configuration is not complete, the example process 300 loops back. If the configuration is complete, the product configuration is transmitted (324). In some examples, the browser application 224 (executing the VPC 206) transmits the product configuration (data) to the configuration server 210 and/or the application 212. The product configuration is verified and is saved (326). For example, the configuration server 210 performs a consistency check (hash-sum), as described herein, and save the product configuration in a temporary mode.

In some implementations, and as described herein, during a checkout process, the application 212 triggers the configuration server 210 to save the product configuration in the database 216 and generate a configuration key. For example, the checkout process can include the user confirming purchase of the configured product, and in response, the application 212 sends a message to the configuration server to T save the product configuration in the database 216 and generate a configuration key. In some examples, after the order is complete, the application 212 can send a message to the browser application 224 instructing the browser application to delete the VPC 206 from the browser cache (e.g., at the end of the session).

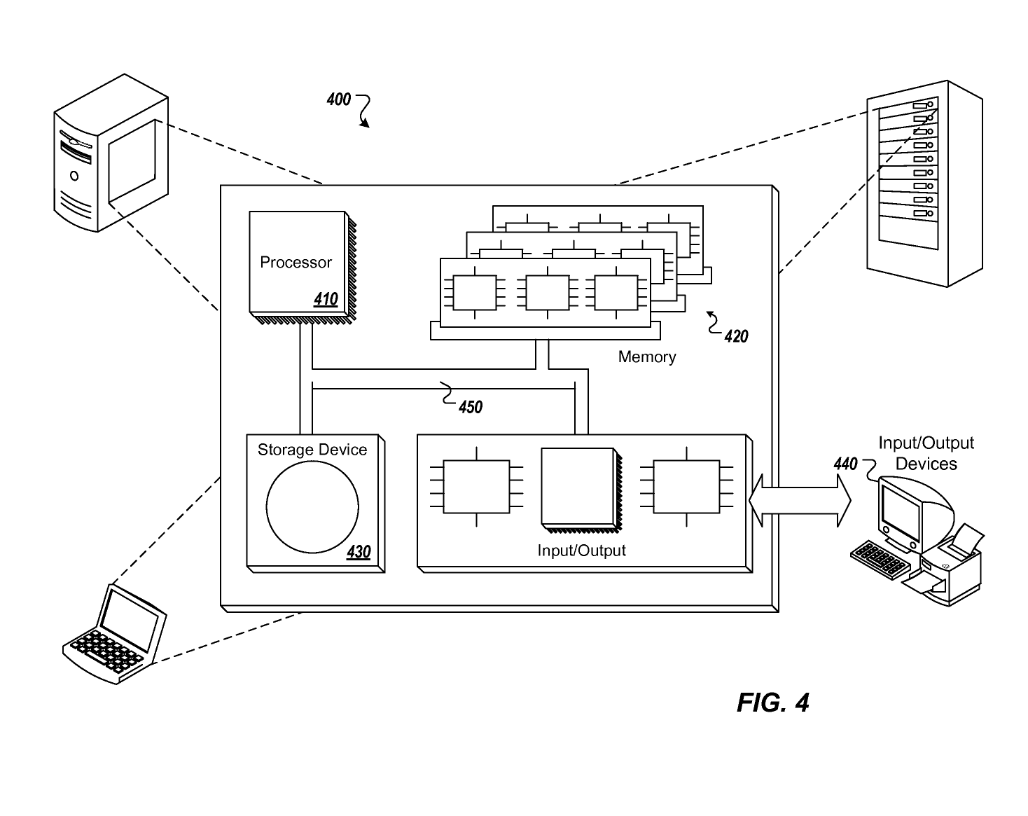

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for configuring products based on a client-side product configurator, the method being executed using one or more processors and comprising:
transmitting, by the one or more processors, a variant product configurator (VPC) to a client-side computing device, the VPC comprising instructions the are executable to configure a product;
receiving, by the one or more processors, a first request, and in response, transmitting default product configuration data to the client-side computing device;
receiving, by the one or more processors, a second request, and in response, transmitting complete product configuration data to the client-side computing device, the complete product configuration data being stored in an in-memory database;
receiving, by the one or more processors, product configuration data comprising one or more user-selected features for the product and corresponding pricing information; and
storing the product configuration data in computer-readable/-writable memory.

2. The method of claim 1, wherein one or more of the default configuration data and the complete configuration data are provided based on one or more sub-models.

3. The method of claim 2, wherein the one or more sub-models are provided based on at least one variant configuration model.

4. The method of claim 1, further comprising verifying an integrity of the product configuration data based on a hash-sum value.

5. The method of claim 1, wherein the VPC is stored in a cache of a browser application and is executed by the browser application.

6. The method of claim 1, wherein the first request and the second request are transmitted based on the instructions of the VPC.

7. The method of claim 1, wherein the VPC is transmitted in response to one of a user navigating to a page of a website, and the user logging into the website.

8. A non-transitory computer-readable storage medium coupled to one or more processors and having instructions stored thereon which, when executed by the one or more processors, cause the one or more processors to perform operations for configuring products based on a client-side product configurator, the operations comprising:
transmitting a variant product configurator (VPC) to a client-side computing device, the VPC comprising instructions the are executable to configure a product;
receiving a first request, and in response, transmitting default product configuration data to the client-side computing device;
receiving a second request, and in response, transmitting complete product configuration data to the client-side computing device, the complete product configuration data being stored in an in-memory database;
receiving product configuration data comprising one or more user-selected features for the product and corresponding pricing information; and
storing the product configuration data in computer-readable/-writable memory.

9. The computer-readable storage medium of claim 8, wherein one or more of the default configuration data and the complete configuration data are provided based on one or more sub-models.

10. The computer-readable storage medium of claim 9, wherein the one or more sub-models are provided based on at least one variant configuration model.

11. The computer-readable storage medium of claim 8, wherein operations further comprise verifying an integrity of the product configuration data based on a hash-sum value.

12. The computer-readable storage medium of claim 8, wherein the VPC is stored in a cache of a browser application and is executed by the browser application.

13. The computer-readable storage medium of claim 8, wherein the first request and the second request are transmitted based on the instructions of the VPC.

14. The computer-readable storage medium of claim 8, wherein the VPC is transmitted in response to one of a user navigating to a page of a website, and the user logging into the website.

15. A system, comprising:
a computing device; and
a computer-readable storage device coupled to the computing device and having instructions stored thereon which, when executed by the computing device, cause the computing device to perform operations for configuring products based on a client-side product configurator, the operations comprising:
transmitting a variant product configurator (VPC) to a client-side computing device, the VPC comprising instructions the are executable to configure a product;
receiving a first request, and in response, transmitting default product configuration data to the client-side computing device;
receiving a second request, and in response, transmitting complete product configuration data to the client-side computing device, the complete product configuration data being stored in an in-memory database;
receiving product configuration data comprising one or more user-selected features for the product and corresponding pricing information; and
storing the product configuration data in computer-readable/-writable memory.

16. The system of claim 15, wherein one or more of the default configuration data and the complete configuration data are provided based on one or more sub-models.

17. The system of claim 16, wherein the one or more sub-models are provided based on at least one variant configuration model.

18. The system of claim 15, wherein operations further comprise verifying an integrity of the product configuration data based on a hash-sum value.

19. The system of claim 15, wherein the VPC is stored in a cache of a browser application and is executed by the browser application.

20. The system of claim 15, wherein the first request and the second request are transmitted based on the instructions of the VPC.
